(19) United States
(12) Patent Application Publication
(10) Pub. No.: US 2013/0058472 A1
(43) Pub. Date: Mar. 7, 2013

(54) Digital Network-Based Telephone Systems and Functionality

(71) Applicant: Edward de Jong, San Jose, CA (US)

(72) Inventor: Edward de Jong, San Jose, CA (US)

(21) Appl. No.: 13/313,408

(22) Filed: Dec. 7, 2011

Related U.S. Application Data
(60) Provisional application No. 61/531,365, filed on Sep. 6, 2011.

(51) Int. Cl. H04M 3/42

(52) U.S. Cl. 379/202.01

(57) ABSTRACT

A conferencing bridge includes a computerized appliance, a non-transitory physical memory medium coupled to the computerized appliance, software executing on the computerized appliance from the non-transitory physical medium, and telephone numbers for a plurality of persons associated with identification for the persons. A user configures a conference by entering and storing a time and date for the conference and identification of one or more desired participants, and at the time and date configured the conference bridge dials out to the one or more participants, and the participants who answer are joined in the conference.

### CROSS-REFERENCE TO RELATED DOCUMENTS

The present application claims priority to U.S. provisional application 61/531,365, filed Sep. 6, 2011, which is incorporated herein in its entirety, at least by reference.

### BACKGROUND OF THE INVENTION

1. Field of the Invention

The present invention relates generally to the field of telephony communication and pertains particularly to systems and methods for data network teleconferencing and conference control.

2. Discussion of the State of the Art

In the field of telephony communication, the live exchange and mass articulation of information among several persons and machines remote from one another but linked by a telecommunications system, or teleconferencing as known in the art, has been an important area of new research. State of the art telecommunication systems may support the teleconference by providing audio, video and/or data services by various means such as telephonic or computerized devices, television or radio.

Internet teleconferencing involves conducting a teleconference over a Wide Area Network or the Internet, and has made teleconferencing available to a far greater audience enabling the use of a variety of computerized or telephonic devices, and has been an area of wide research. A key technology and major development in this area was the introduction of mass-market Voice over Internet Protocol (VoIP) services that utilize existing broadband Internet access, by which subscribers place and receive telephone calls in much the same manner as they would via the public switched telephone network (PSTN).

State of the art web conferencing technologies have emerged that have incorporated the use of VoIP audio technology allowing for completely web-based communication, and applications include meetings, training events, lectures or short presentations from any Internet connected computer, participants being an individual person or a very large group. In current systems support for planning a shared event is typically integrated with calendar and email applications, and the method for controlling access to an event can be provided by an enterprise subscribed to a web conferencing service, for example, utilizing an Internet provider providing VoIP technology.

A mechanism for membership, authorization and web conference initiation and participant notification control is included in a list of standardization requirements for state of the art systems. In such systems the control mechanisms are typically provided by “bridge” software executing on an Internet connected server or group of servers providing VoIP telephony services. Conferencing bridge systems are well-known in the art, and the conferencing event coordinator representing the enterprise, for example, and wishing to propose and initiate a conferencing event accesses the bridge software, and typically provides an access number which persons invited to the conference may call to access the bridge and accept the invitation. The process typically requires the invited participants to enter a special access code that has been provided by the conference organizer or initiator. Typically the conference is then activated by the organizer by entering a special access code available only to that user.

In state of the art web conferencing bridge systems, several problems present themselves in coordinating communication with a group of potential conference participants. A primary problem for example, is if a conference is to begin promptly at a particular time, persons previously invited to the conference may be late in joining the conference, or may not join at all, and the participants who have already joined are inconvenienced by the wait for late participants and unknown status of other invitees who may or may not join, and a preferred conference start time may be delayed due to such inconsistencies. Further, as is often the case with conferences, the subject matter of the conference, and the order and timing of different items of issue to be presented may require participation from different persons at different times, and for many conference participants joining a conference at the wrong time is not an efficient use of their time, nor is it conducive to the overall success of the conference. Still further, potential conference participants may be reachable only at certain times of the day or week, and the communication device with which they can be contacted may change depending on the time of day or day of the week. Further problems exist in state of the art conferencing systems including participant lack of familiarity with behavior and protocol, equipment and technology, poor coordination by conference initiators or lack of adequate moderation.

These and other such conference participant communication and coordination problems are inherent in state of the art conferencing bridge systems. It has occurred to the inventors that if added communication coordination intelligence and potential conference participant data parameters were to be incorporated into a cross-platform conferencing system at the bridge level, efficiency of such communication coordination for potential participants would be significantly increased.

Therefore what is clearly needed is a web conferencing bridge system and method wherein the mechanism for potential conference participant communication coordination is an automated process performed at the bridge level, said coordination based on intelligent extrapolation of stored pertinent data parameters regarding potential conference participants, and the potential conference participants are contacted by the bridge in order, in parallel or selectively for invitation to join the conference based on the stored information pertinent to the potential participants.

### SUMMARY OF THE INVENTION

A conferencing bridge is provided in an embodiment of the invention, having a computerized appliance, a non-transitory physical memory medium coupled to the computerized appliance, software executing on the computerized appliance from the non-transitory physical medium, and telephone numbers for a plurality of persons associated with identification for the persons. A user configures a conference by entering and storing a time and date for the conference and identification of one or more desired participants, and at the time and date configured the conference bridge dials out to the one or more participants, and the participants who answer are joined in the conference.

In one embodiment of the invention participants dialed are asked to respond that they are joining, before the bridge adds the dialed telephone into the conference. Also in one embodiment the bridge stores alternative telephone numbers and messaging addresses for the desired participants, and a preferred order of messaging for each, and the bridge, at the time of the conference, accesses the stored information, accesses an appropriate messaging channel, and messages the desired participants according to the stored alternative numbers and addresses.

In some embodiments the response by the desired participants is a pre-assigned digit or digit sequence. Also in some embodiments a response mechanism compatible with the appropriate messaging channel selected is implemented. A conference may be configured with a list of participants, but without a time and date, and the user may access the bridge through an interactive interface to start a conference.

In one embodiment the user, through the interactive interface, selects once to message all persons in the list to start a conference. Also in one embodiment the user, through the interactive interface, selects individual participants form the list, one-at-a-time or in sub groups, rather than all desired participants to initiate a conference. In some cases the user is notified as each participant joins the conference. Further the interactive interface may include a whisper function whereby the user is informed of specific aspects of the conference as the conference continues, and the whisper is not heard by other participants.

### BRIEF DESCRIPTION OF THE SEVERAL VIEWS OF THE DRAWINGS

FIG. 1 is a block diagram of a network-based communication system which may be used to implement a system and method according to embodiments of the invention.

FIG. 2 is a block diagram illustrating functionality of a conferencing bridge system according to an embodiment of the invention.

FIG. 3 is a flowchart illustrating an exemplary process for identifying and contacting potential teleconference participants according to a preferred embodiment of the invention.

### DETAILED DESCRIPTION OF THE INVENTION

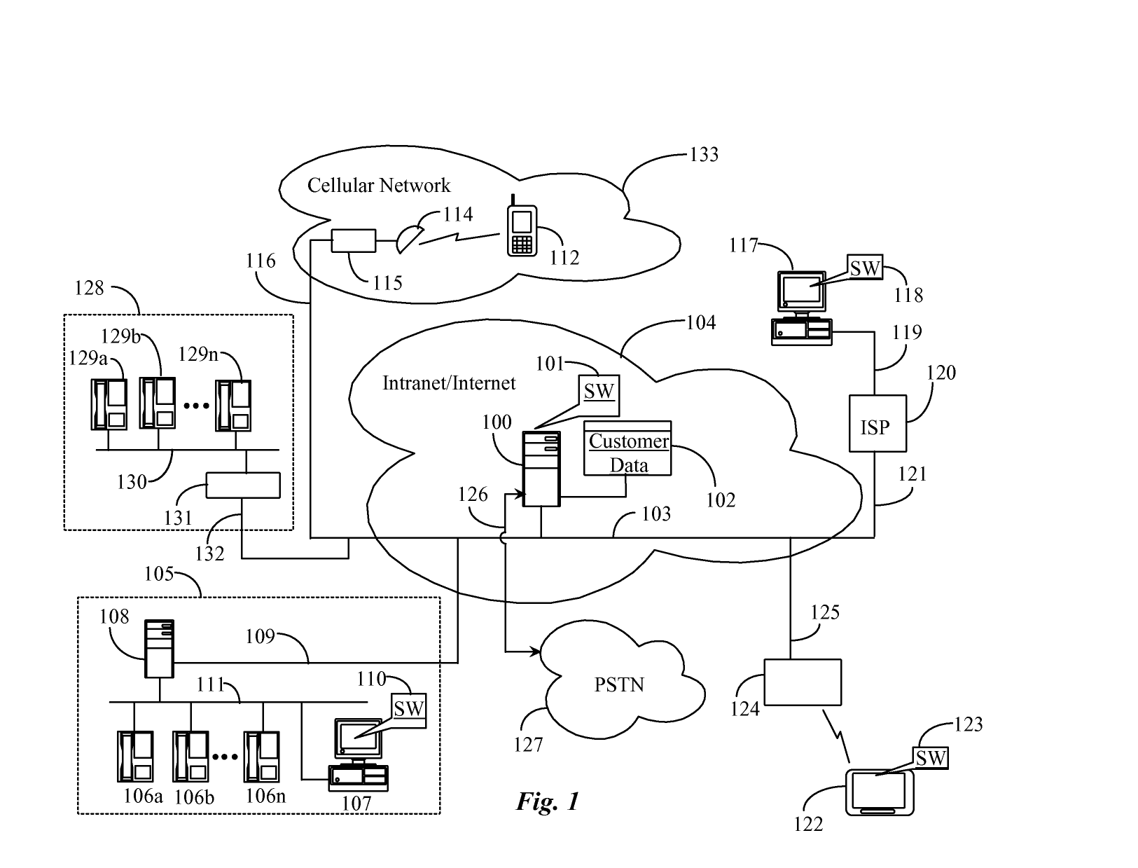

The invention pertains to an Internet-based voice over internet protocol (VoIP) web conferencing bridge system and method providing unique functionality in conference participant communication coordination not available in state of the art systems at the time of filing of the present application. FIG. 1 is an architectural diagram of a network-based communication system which may be used to implement a system and method according to an embodiment of the present invention. Any or all of the software (SW) applications and or servers in the following description can be single, clustered or load-balanced to allow scaling up the system capacity and/or improving system reliability and/or improving system response times. Additionally, terminal devices, also referred to as networked terminal devices herein, include but are not limited to networked wireless communication devices such as micro-browser enabled cellular telephones, personal and laptop computers, computer terminals, palm-sized computing devices, personal digital assistants (PDA's). Such terminal devices typically have a user interface comprised of a display, an input interface such as a keypad and a pointing device such as a mouse, navigation key set, touchpad or the like.

In the following detailed description of embodiments the present invention numerous specific details are set forth in order to provide a thorough understanding of the present invention. However, it will be apparent to those skilled in the art that the present invention may be practiced without all of these specific details. In other instances, well-known methods, procedures, components and circuitry are not described in detail in order to avoid unnecessarily obscuring the new and novel aspects of the invention.

FIG. 1 illustrates a basic system configuration in which the present invention may be implemented in accordance with a preferred embodiment of the present invention. The system illustrated is a cross-platform communications system generally including a plurality of communications networks such as public switched telephone network (PSTN) 127, Intranet/Internet 104, and wireless cellular network 133. The aforementioned communications networks support communications between pluralities of diverse terminal devices as illustrated by cellular devices represented by cellular phone 112, telephony devices 129a-n and 106a-n, computer 107, tablet device 122 and individual computer 118. All of these networked devices as represented in the illustration can be either a single or plurality of devices without departing from the scope and spirit of the invention.

Line 103 represents all of the interconnecting structure and packet-routing capability in the Internet. Server 100 executing software 101 is an Internet-connected server providing VoIP telephony services according to various embodiments of the present invention, many of which are new and unique, and which are described in enabling detail further in this specification. In practice, server 100 may be a group of servers providing specific services in the invention, and the plurality of servers may or may not be geographically common. Server 100 is coupled to a data repository 102 which stores customer data, including configuration and customer preferences also described in additional detail below.

Server 100 represents one or a plurality of servers of an Internet telephony service provider (ITSP) offering subscribing business enterprises and residential customers (clients) digital telecommunications services based on VoIP provisioned via the Internet. The ITSP, or VoIP provider, uses a variety of signaling and multimedia protocols including but not limited to Session Initiated Protocol (SIP) and Media Gateway Control Protocol (MGCP). Subscribing businesses and residential customers connect with server 100 and access the services provided according to different embodiments of the invention, preferably through use of terminal devices such as mentioned above, that are enabled for VoIP and capable of Internet connectivity, either directly or through any of a variety of service providers and gateways. In some cases clients of the VoIP provider may access some services provided by server 100 and participate in some functions of the services using communication appliances that are not VoIP-enabled, such as traditional analog telephone devices coupled to an analog telephony adapter (ATA) to connect to the VoIP service provider's network via a local area network (LAN), or the clients may connect a private branch exchange (PBX) system to the service via media gateways. There are many possibilities.

FIG. 1 illustrates a small business 105 which represents one or a plurality of enterprises that have subscribed to the VoIP services of sever 100. Business 105 comprises a LAN 111 to which each of a plurality of telephony devices 106a-n are connected, as well as one or a plurality of personal computers 107. In this example telephony devices 106a-n are enabled with VoIP and SIP through onboard software or firmware, and computer device 107 is also enabled with VoIP with a version of SIP deployed through SW 110 enabling the initiation and receipt of voice calls utilizing a microphone and speaker which may be joined in a headset, for example. In addition to one or more computer devices 107 connected to LAN 111, business 105 may also comprise a plurality of other VoIP-enabled communication devices connected to the LAN. In the present invention SIP is but one protocol that may be used in conjunction with VoIP, and in some embodiments other protocols may be used without departing from the scope and spirit of the invention. A server 108 acts as a gateway between LAN 111 and server 100 in the Internet. Gateway server 108 connects to the Internet backbone 103 via connection line 109. Users at stations in the business enterprise may place and receive calls, and access a variety of services offered by server 100 through the LAN-connected devices 106a-n or 107.

The network-based communications system of FIG. 1 also has a residential system 128 which represents one or a plurality of home-based systems comprising telephony devices 129a-n connected via LAN 130, which may be a wireless network, or the appliances may be connected by cable to a router/modem 131. Router/modem 131 in this example is connected by digital subscriber line (DSL) to the home's telephone service, and hence to the Internet backbone 103 by connection line 132, providing Internet access for the home communication devices. Internet connection in this system may be provided through other than a DSL system, such as cable service, or any other preferably high-speed Internet connection service. Telephony devices 129a-n are preferably VoIP/SIP enabled. Other devices not shown in residential system 128 such as laptop computers, tablet computers, and the like, may also be connected through router/modem 131 through a wireless network or by Ethernet for example, and may be used in the premise for interaction with server 100.

The communications system of FIG. 1 has a wireless cellular network 133 comprising one or a plurality of cellular communication devices represented by cellular telephone 112, a network of base stations represented by element 114 and a cellular service 115 which acts as a gateway to the Internet via line 116. The system of FIG. 1 also illustrates one or a plurality of individual computers represented by computer 117, which could be desktop or laptop computers for example, and preferably also enabled with VoIP with a version of SIP deployed through SW 118. Computers 117 may interact with and access services provided by server 100 through Internet Service Providers (ISPs) 120 via connection line 119 between the computers 117 and ISPs 120, and line 121 between ISPs 120 and Internet backbone 103.

As further illustrated in FIG. 1, one or a plurality of individual tablet computers as represented by tablet device 122, which are also enabled with VoIP and a version of SIP through SW 123, may interact with and access services provided by server 100 through wireless networks 124 connected to Internet backbone 103 by connection line 125. Various other devices enabled for wireless connection, such as laptops and PDA's or other such devices enabled with VoIP and a version of SIP or other protocol may interact with and access server 100 in the same manner.

FIG. 1 further illustrates a PSTN represented by network cloud 127. PSTN 127 is connected to server 100 by hardwired lines 126, providing pathways for VoIP-enabled users of the services of server 100 to initiate transactions with persons using plain old telephone service (POTS) communication devices, and for persons using POTS devices to interact with services offered by server 100, and to interact with other users operating VoIP-enabled devices.

The architecture described above embodies a basic cross-platform communications system configuration in which the present invention may be implemented in accordance with a preferred embodiment of the present invention. The present invention solves problems as described in the background section regarding conference participant communication and coordination that are inherent in state of the art conferencing bridge systems, by providing an improved conferencing bridge system and method for web-based conference initiation and efficient contacting of potential conference participants.

Conferencing bridge systems are well-known in the art, being a specialized type of hardware equipment enhanced with software and typically maintained by a specialized service provider who may also provide phone numbers and access codes that conference participants dial to access a meeting or conference call. Bridge software acts as the conference “bridge” controlling the conference and the individual conference participants at a high level, while low-level media operations such as audio mixing, prompt playing and dual-tone multi-frequency (DTMF) signaling, are performed on a media server resource that is being controlled by the bridge software application software.

A primary problem in state of the art conferencing systems is if a conference is to begin promptly at a particular time, persons previously invited to the conference may me late in joining the conference, or may not join at all, and the participants who have already joined are inconvenienced by the wait for late participants and unknown status of other invitees who may or may not join, and a preferred conference start time may be delayed. Further, the subject matter of the conference and the order it is to be presented may require participation from different persons at different times, and for many conference participants joining a conference at the wrong time is not an efficient use of their time and may be a detriment to the overall success of the conference and the expected results of the conference may not be realized. Another problem presents itself in state of the art systems, wherein potential conference participants may be reachable only at certain times of the day or week due to time-sensitive contact availability, and the communication device with which they can be contacted may change depending on the time of day or day of the week. For example, it is not unusual for one or more of the conference participants to have multiple terminal devices (e.g. cell phone, network-connected computer or other computing device, multiple land lines, etc.). In such a typical environment, it is incumbent upon the conference initiator/coordinator to take all of the above factors into consideration in order to successfully coordinate and initiate a multi-point telephone conference.

Considering a situation in which a conference coordinator wishes to propose a multi-point telephone conference business meeting with a plurality of participants for which some information is known, such as a name identifier and some form of contact information, successful coordination and initialization of the multi-point telephone conference from a location remote to that of an associated teleconference server (i.e., server 100 of FIG. 1) implies the confluence of several conditions, namely: a) the selected participants have access to a terminal device, b) the coordinator has provided all of the correct contact information for the particular terminal devices for which the participants have access, c) the coordinator is able to initiate communication to the particular terminal device or devices (either directly or through an intermediate server device) which are accessible to the selected participants at the time of the conference invitation delivery, d) each of the selected participants join the conference at a time that best coincides with the presentation order and timing of different items of issue in the subject matter of the conference, and e) the activities of the coordinator, the participants and the associated teleconference server can be coordinated at the appointed time of the multi-point teleconference from the respective locations of all parties involved.

An exemplary process in current state of the art systems has that once a conference is set up and proposed by a coordinator, invitations comprising information about the conference including descriptive information and possibly a primary and secondary start time and conference duration, are sent out to the terminal devices of selected participants. The potential participant receives the invitation and can accept either start time, or decline the invitation. The participant responses are received by the coordinating server and the conference coordinator wishing to set up the conference accesses a conference setup application and creates or selects an existing conference to modify, and inputs the conference information or modifies existing conference information via a terminal device interactive interface. A determination is then made as to whether the information provided by the coordinator and that retrieved by the resident software agents has been processed, and then a determination is made as to whether the coordinator wishes to forward the invitations to the selected participants and if affirmative, the coordinator forwards the invitations to the potential participants. A determination is then made whether all of the participant responses have been received, of if a pre-established time limit for response receipt has expired. Upon receipt of all the responses or expiration of the time limit, the responses are processed and the information is forwarded to the coordinator. The system then determines as to whether the final instruction/conformation has been received from the coordinator. The coordinator may then select timed conference initiation or manual conference initiation. If manual initiation is selected, the coordinator selects the conference to initiate and activates the conference via an input element of an interactive interface of a terminal device, which prompts a coordinating server device to prompt a telephone conference server to initiate calls to the selected participants and to the coordinator.

Applicant's invention on the other hand provides an Internet-based voice over internet protocol (VoIP) web conferencing bridge system and method providing unique and much-simplified functionality in conference participant communication coordination not available in current state of the art systems at the time of filing of the present application. In applicant's invention the mechanism for potential conference participant communication coordination is an automated process performed at the bridge level, said coordination based on intelligent extrapolation of stored pertinent data parameters regarding potential conference participants, and the potential conference participants are contacted by the bridge in order, in parallel or selectively for invitation to join the conference based on the stored information pertinent to the potential participants. In applicant's invention described below in enabling detail, bridge conferencing functionality is provided wherein the system that provides the conference bridge need not wait for participants to call into the conference before starting the conference, by proactively contacting or “reaching out” to persons selected for conference participation rather than requiring them to call into the conference call, and does so in sequential order, in parallel or selectively. The inventors have termed this functionality as “Huddle” conferencing, and the organizer/coordinator of the conference may be considered the “Quarterback”.

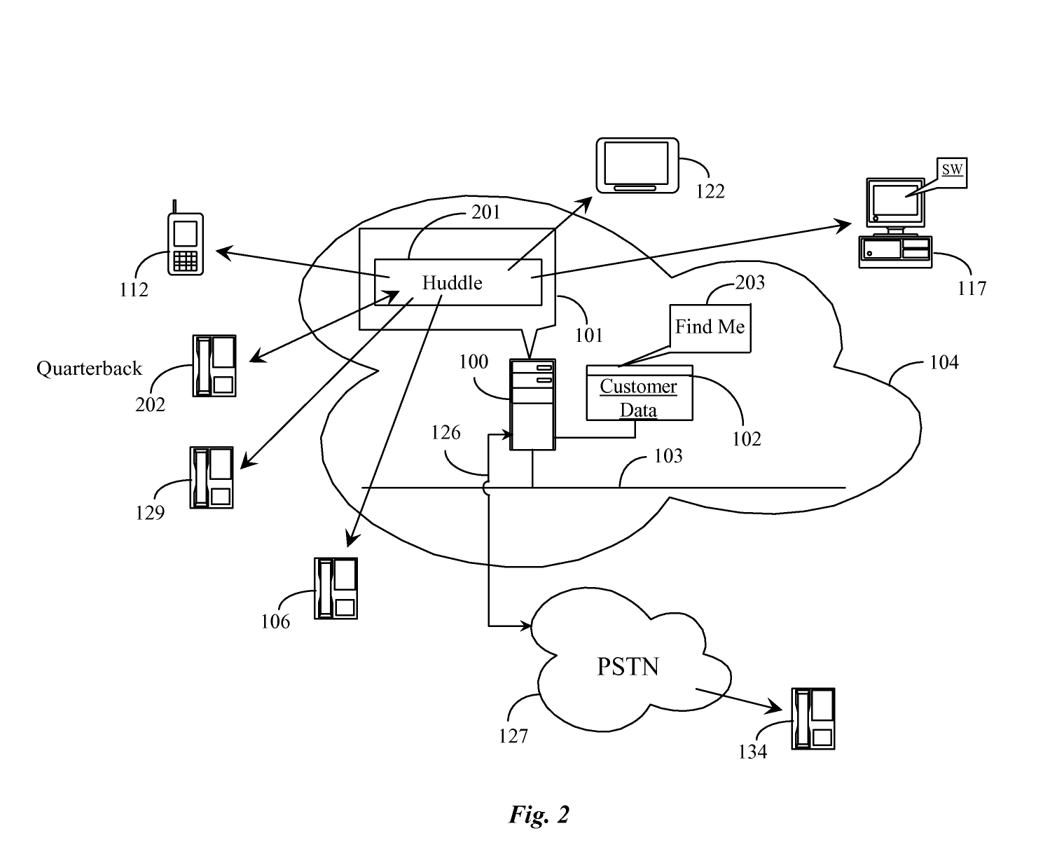

FIG. 2 is a block diagram illustrating the unique Huddle functionality of a conferencing bridge system according to an embodiment of the invention, and is a simplified illustration graphically depicting said functionality. Huddle is functionality as part of software 101 executed by server 100 (see FIG. 1), and is represented in FIG. 2 by element 201 labeled “Huddle”. The unique and advantageous functionality of Huddle software will be described further below in the specification in enabling detail. Many of the elements of FIG. 1 are shown, such as telephony devices (106, 129, and 134), cellular devices 112, tablet devices 122 and individual computing devices 117; however, some specific details illustrated in FIG. 1 have been omitted from the illustration and description in the interest simplicity and redundancy avoidance.

Server 100 may be a plurality of servers which may or may not be geographically common, providing VoIP telephony and other specific services according to embodiments of the invention, such as teleconferencing service and coordination of communications thereof. Storage means represented as data repository 102 stores software such as a Lightweight Directory Access Protocol (LDAP) module for storing attribute data, contact and schedule information for a plurality of subscribers and any associated software applications, and providing means for obtaining information from different vendor applications (i.e., such as email or contact lists) and databases which may be resident on diverse platforms.

The preceding and following description of server 100 is provided for purposes of illustration and not limitation. It would be understood by one of skill in the art that the present invention may be practiced in a computer system or systems having single or multiple processing units, and system components that differ from those described or illustrated.

Telephony device 106 may represent a plurality VoIP/SIP enabled devices in a small business enterprise, for example, connected by LAN which may include VoIP/SIP enabled computers and a gateway server enabling Internet connection of the LAN-connected devices to server 100, and access to the services provided therein. Telephony device 129 may represent a plurality VoIP/SIP enabled devices in a residential system, for example, connected by LAN which may access to server 100 and to the services provided therein utilizing a variety of Internet connection service means. PSTN 127 connected to server 100 by hardwired lines 126 provides pathways for VoIP-enabled users of the services of server 100 to initiate transactions with persons using POTS devices such as telephony device 134, and for persons using such POTS devices to interact with services provided by server 100 and to transact with other system-connected users operating VoIP-enabled appliances.

Telephony device 202 represents a terminal device from which a telephone conference coordinator termed “Quarterback”, in the Huddle conference system of the invention, may initiate and coordinate a multipoint telephone conference. In practice of the invention, the Quarterback may initiate the conference from any of the terminal devices associated with the cross-platform communications system of the invention, illustrated in more detail in FIG. 1. For example, using a land-based telephony device such as device 134 the Quarterback may access the coordinating services of server 100 via a standard switch telephone network and associated connection circuitry (not shown in FIG. 1). Using a personal computer such as device 117 the Quarterback may access server 100 via the Internet, using a wireless cell phone such as device 112 the Quarterback may access server 100 via wireless network, and so on. There are many possibilities. Device 202 represents any of the terminal devices that may be utilized by the Quarterback in initiating and coordinating a telephone conference.

Server 100 is an Internet-connected server or group of connected servers which may or may not be geographically common, providing VoIP telephony services, cross-platform teleconferencing services and teleconference coordination capability. Server 100 executing software 101 provides these services as well as maintaining specialized hardware enhanced with software which provides unique conferencing bridging and automatic calling functionality. Such functionality is provided by Huddle software 201, which is functionality as part of software 101.

Data repository 102 stores a software module for storing attribute data, contact and schedule information for a plurality of subscribing teleconference participants, and any associated software applications, and provides means for obtaining information from different vendor applications and databases which may be resident on diverse platforms. Data repository 102 also stores established parameters for contacting each of a plurality of teleconference participants. The automatic calling functionality of SW 201 operates together with data repository 102 in setting up a teleconference and proactively contacting potential teleconference participants.

In one embodiment of applicant's invention conference participant data parameters stored in data repository 102 may be configured as a system profile by conference participants utilizing GUI software, for instance, associated with a participant terminal device. The inventors of the present application term this feature as “Find Me”, and this feature is illustrated as element 203 of FIG. 2, being a subset of data available in data repository 102. Typically, the potential participant's contact telephone number(s) are included in the profile. However, in this embodiment the participant's system profile may contain contact information that is much more granular than the participant's name associated with one or more telephone numbers where they may be contacted. For example, a potential participant profile may also include one or more additional unique identifiers such as an alphanumeric descriptor, employee number, or any other unique identifier that may be useful or desired.

Further, and more importantly, the participant “Find Me” profile may include a phone number prioritization list indicating the priority order of the phone numbers associated with each of the plurality of potential participants. In such a case, the automatic calling functionality of the Huddle software performs the outgoing conference invitation calls following a phone number prioritization listing and automatically calls each designated teleconference participant using the designated participant's highest priority phone number first. If the participant does not answer the first automatic call, the next highest priority number is automatically called, and so on, until all of the numbers in the prioritization list have been called. Still further, the potential conference participant's profile may include contact telephone numbers which have associated flags that designate which, if any, of the numbers to be omitted from the prioritization listing, or the flags may include additional preference settings, such as a flag may be set for specific dates or times of the day when the number would be temporarily omitted from the prioritization listing, or dates and times of the day that the numbers would be included in the listing. There are many possibilities. In some embodiments the conference organizer, or Quarterback, may pre-configure a Huddle conference and store conference participant data parameters as described above. In other embodiments the conference participant's terminal device connected to and accessing the services of server 100 may include a user application including GUI whereby the conference participant may easily create, edit and update their system profile as needed.

The automatic calling feature of the Huddle conferencing bridge system may include a process for systematically determining an optimal number to call a designated teleconference participant at first based on detailed information in the participant's profile as described above, and may also include a process for automatically making a series of subsequent calls if the first call is not answered, subsequent calls being subject to an automatic determination based on the participant profile information.

Still further, and uniquely advantageous to systems of the present state of the art, is that in addition to the systematic process for contacting potential conference participants based on the “Find Me” profile information described above, the automatic calling functionality provided by applicant's Huddle conferencing system enables the teleconference coordinator, or “Quarterback” to command the automatic calling system to call selected conference participants either in sequential order, in parallel or selectively.

In practice of the invention according to a preferred embodiment as illustrated in FIG. 2, the conference organizer/coordinator, or Quarterback 202 wishing to propose a telephone conference, accesses a conference setup application resident on server 100 by inputting via an Internet-connected terminal device, an appropriate uniform resource locator (URN) or similar location address. The Quarterback may then create a new teleconference or select an existing teleconference to modify, wherein the Quarterback inputs the teleconference information or modifies existing teleconference information. The Quarterback may select a pre-defined list of potential conference participants of the “Huddle”, or select participants individually from a list. The system does not need to identify the Huddle Quarterback because when the QB calls the huddle the system will not include the QB in the list of participants that will be called.

The information provided by the Quarterback and conference data retrieved by the resident bridge software agents of server 100 is processed, and upon completion of processing, a determination is made as to whether the QB wishes to forward the invitations to the selected participants, or “call the huddle”. If the determination is affirmative the invitation calls are forwarded to the selected participants.

As previously mentioned, the QB may command the automatic calling system to call selected conference participants either in sequential order, in parallel or selectively. For example, based on the subject matter of the conference, and the order and timing of different items of issue to be presented, there may be a pre-configured list of participants to be included in the huddle at the beginning of the conference, and additional participants may need to be sequentially added in the huddle at specific times. The order and timing of different items of issue to be presented in the conference may also dictate that different parallel groups of participants may need to be added to the huddle at specific times. In other cases the QB may selectively add participants to the huddle from a pre-defined list of potential participants, one at a time. The flexible nature of the Huddle conferencing bridge process enables the QB to tailor the order, timing and selection of huddle participants to meet the needs of, and obtain the best expected results from the teleconference.

Referring again to FIG. 2, once the conference has been determined by the QB, and all of the participants have been selected including the order in which they are to be included in the huddle, the automatic calling feature of bridge 201 establishes the calls to each of the huddle participants. These calls are indicated in FIG. 2 by arrows proceeding from bridge 201 to individual devices such as cellular device 122, tablet device 122, individual computer device 117, telephone (POTS) device 134, and telephone (VoIP/SIP) devices 106 and 129. Outgoing huddle invitation calls to cellular devices such as 112 can be made either through PSTN to cellular provider or through VoIP service to cellular provider, and calls to SIP devices such as 129, 106, 117 or 122 can be made over the Internet connections. Calls may be made to pluralities of diverse terminal devices as illustrated by the devices shown, and are made by whichever means is appropriate to the particular devices.

In some embodiments of the invention, the huddle conferencing system uses the participant's stored profile data to indicate to the QB as each participant joins the huddle, as well as each participant who does not. The QB may invoke a command to query the system about various aspects of the huddle as the teleconference continues. Such information may be provided to the QB by “whisper” wherein other conference participants are not made aware of the information as the conference continues.

The huddle teleconferencing system makes the calls to the designated teleconference participants at a preset time, or as manually initiated by the QB, based on established data parameters stored in data repository 102 pertaining to the potential participants and to the teleconference itself, without the need for the teleconferencing participants to call in to the teleconference. The parameters include participant profile as described above as well as parameters pertaining to the subject matter of the teleconference, and the order of its presentation. However, from the above description of the automatic calling capability of the Huddle conferencing bridge system of the invention, it should be generally understood that calls are not made to designated teleconferencing participants who have already called in and joined a teleconference. It is the capability of the teleconferencing bridge calling system in initiating a teleconference and making the calls to potential teleconferencing participants without requiring them to call in to the teleconference beforehand, and the ability to automatically call potential participants in sequential order, in parallel or selectively from a list that is at the heart of applicant's invention.

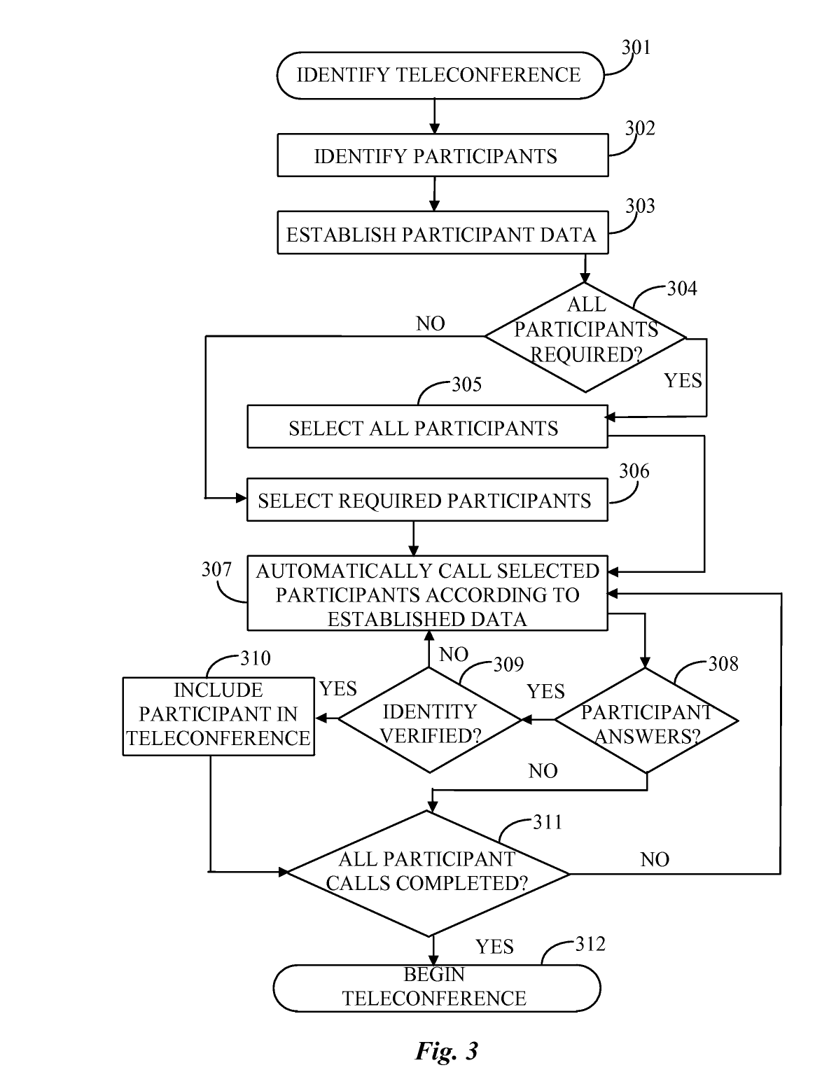

FIG. 3 is a flowchart illustrating an exemplary process for identifying and contacting potential teleconference participants according to a preferred embodiment of the invention. In the flowchart illustrated, step 301 includes identifying the teleconference, and possibly its subject matter and the content presentation as well as the order and timing in which different issues to be discussed will be presented. Based on such teleconference information a list of total potential teleconference participants is selected in step 302, which illustrates that for any particular teleconference, certain participants may be designated to participate in the teleconference. For each of the potential teleconference participants, data parameters are established in step 303. These parameters are used to establish a system profile for the potential participant, as previously described above in the specification. A determination is then made in step 304 whether or not all of the participants identified in step 302 are required to participate in the teleconference. If all of the participants from the list of total potential teleconference participants are required to participate, then all potential participants from the list are selected in step 305 for teleconference participation. However, as is often the case, the final list of designated participants is a subset of the total potential participant list, such as when the subject matter of the teleconference and the different related issues and the order in which each issue is to be presented necessitates the inclusion or omission of different participants or sets of participants at different times. If this is the case, only the required participants are selected in step 306. Once the participants are selected in steps 305 or 306, the calling function of the huddle bridge system automatically calls each of the selected participants based on the parameter data that were established in step 307. When a designated participant answers the automatic call in step 308 and has their identity verified in step 309 and the participant accepts the teleconference invitation, they are included to participate in the teleconference in step 310. However, if the designated participant answers a call and their identity is not verified by the system in step 309, then the system reverts back to step 307 and the established data parameters of the designated participants are checked in order to determine the next call to make. Alternatively, if the participant does not answer the automatic call, then the system performs step 311 and determines if all of the participant calls have been completed in accordance with the established data parameters of all the designated participants. If all of the participant calls have not been completed, then the system returns to step 307 to resume automatic calling. If, on the other hand, all of the participant calls have been completed, then the teleconference is set up and can be initiated for commencement in step 312.

In some cases a designated teleconference participant will not answer any of the automatic calls made by the system during a first pass through the contact phone number prioritization listing. In such a case the system may utilize various different prioritization arrangements, such as repeating the automatic calling of all or a designated subset of the phone numbers included in a phone number prioritization listing for a designated teleconferencing participant.

Huddle conferences may be formed according to many different criteria, such as family meetings with certain family members, sports team members and their coaches, business meetings perhaps defined by sales, marketing, research, specific projects and the like. The invention may be practiced for the purpose of bringing together participants for huddle conferencing based on a near endless variety of criteria and definition.

The teleconferencing bridge system may be integrated with a computer calendaring system wherein the automated system determines designated teleconference participants from a list of participants associated with an automated calendar entry on a teleconferencing coordinator's automated calendar. The teleconferencing bridge calling system may also automatically the outgoing calls to participants at a preset time before an and automated conference call calendar entry so that designated teleconference participants are connected to the teleconference at of before the starting time of the teleconference. Alternatively, the teleconference calling out feature may be coordinated with automatic notification and email reminders or text messages to designated teleconference participants. One or more automated and interactive voice messages providing teleconference information may also be provided to participants answering calls made by the calling feature, and depending upon vocal or digital entries made by a designated participant using a phone or similar device, additional automated and interactive voice messages may be provided to the designated participant.

In some embodiments it is important to note a good reason for asking a person to confirm joining is to make sure a) that the person being invited actually picked up the phone, and b) that a human answered the phone not a messaging system of some kind. Also, in some embodiments when inside a group conference, by using an ESCAPE sequence such as the STAR key, any participant can request various features to augment the normal conference, including but not limited to:

a) locking the conference to prevent others from joining

b) unlocking a previously locked conference

c) whispering to the requestor only the list of participants

d) broadcasting to all members the names of the participants

e) returning to normal conferencing mode

A crucial advantage of using a predetermined list of people to dial out and invite to the huddle is that you know who they are already, and when they are added to the conference the system can easily announce their name (which is stored in the database as either text which is converted to speech using the commonly available TTS systems, or as an audio recording), and also announce them when they leave the conference.

It is a well known problem that once a few people have entered or left a conference of a sizable number of people it becomes muddled to the participants who are present. The system of the present invention in some embodiments not only announces who has entered, but has special provisions for reporting the number of participants. For example, during conference formation, the announcements might be something like this:

. . . person A picks up a system phone and dials a code sequence to start a huddle.
. . . person A picks the subset of known people to call, either by picking from a pre-prepared named list like “sales managers” or “family members”, and then they are called and invited to join the conference. As they are joined in the following transcript might occur:
. . . person A joins

BROADCAST: “You are the only one in the conference. Waiting for others to join”

. . . person B joins:

BROADCAST: “Betty has joined. Two present”.

. . . person C joins:

BROADCAST: “Charlie has joined. Three present”.

. . . person D joins:

BROADCAST: “Dave has joined. Four present”

. . . person B leaves . . .

BROADCAST” “Betty has left. Three present”

. . . person C presses escape key:

WHISPER: “to lock the conference press 1, to unlock the conference press 2, to whisper conference participants press 3, to broadcast conference participants press 4, to return to conference press 0”

. . . person C presses 4

BROADCAST “Conference participants are Adam, Charlie, Dave. End of list”

. . . person C presses 1

BROADCAST: “the conference has been locked by Charlie”

. . . person C presses 0, returns to regular conference
. . . person E tries to join the conference, they are told “Sorry this conference is locked, please try again later”

If a person not known to the system joins the conference, they will be asked to announce their name, so that their entry and exit can be announced.

The above transcript of a typical dialog with the controller is highly illustrative, and shows how the system can be initiated, the huddle formation process, and then modifications may be made to the huddle.

In some embodiments of the invention locking a conference and announcing the number of people present prevents three problems:

1) people can lurk on conference bridges, waiting for a meeting, and with a muted microphone eavesdrop on what may be a sensitive conversation

2) people can easily forget who is currently in the conference. many systems just announce people with a tone, and after a few entry/exit tones one could only guess how many and who is left in the conference.

3) if enough people leave the conference, one person may be left alone without knowing it.

The invention has been described above with reference to exemplary embodiments, and therefore it should be understood by those with ordinary skill in the art that terms are used for the purpose of description and illustration, rather than that of limitation. Although the invention has been described with reference to particular means, materials and embodiments, the invention is not necessarily intended to be limited to the particulars disclosed; rather, the invention extends to all functionally equivalent structures, methods and uses as are within the scope of the appended claims.

For example, teleconferencing in the present disclosure may include many media forms in addition to telephone conferencing; thus alternate communication addresses other than phone numbers may be used by the teleconferencing bridge system, and a variety of different terminal devices may be used by both the teleconference coordinator and teleconference participants.

The term “data repository” as used in applicant's disclosure shall also include any computer-readable storage medium and may also include solid state memory or packages housing one or more non-volatile read-only memories capable of storing, encoding or carrying a set or sets of instructions for execution by a computer processor or that cause a computer to perform any one or more of the operations disclosed herein. The disclosure is considered to include any computer-readable medium or other equivalent and successor media in which data and instructions may be stored.

The present disclosure also describes terminal devices and functions that may be implemented in particular embodiments with reference to particular standards and protocols, but it should be understood that the disclosure is not limited to any such standards or protocols. Standards and protocols referenced merely represent examples in the state of the art, and may be periodically superseded by replacement standards or protocols having the same or similar functions, and should be therefore considered equivalents thereof.

One or more embodiments of the disclosure may be referred to herein, individually or collectively, by the term “invention” merely for convenience and without intending to limit the scope of the present application to any particular invention or inventive concept. Although specific embodiments have been illustrated and described herein, it should be appreciated that any subsequent arrangement designed to achieve the same or similar purpose may be substituted for the specific embodiment(s) shown.

The above disclosed subject matter is to be considered illustrative, not restrictive, and the appended claims are intended to cover all modifications, enhancements and other embodiments which fall within the true scope and spirit of the invention as described and illustrated in the disclosure. Thus, the scope of the present disclosure is to be determined by the broadest permissible interpretation to the maximum extent allowed by law, of the following claims, and shall not be restricted or limited by the foregoing detailed description.

1. A conferencing bridge, comprising:
a computerized appliance;
a non-transitory physical memory medium coupled to the computerized appliance;
software executing on the computerized appliance from the non-transitory physical medium; and
telephone numbers for a plurality of persons associated with identification for the persons;
wherein a user configures a conference by entering and storing a time and date for the conference and identification of one or more desired participants, and at the time and date configured the conference bridge dials out to the one or more participants, and the participants who answer are joined in the conference.

2. The bridge of claim 1 wherein participants dialed are asked to respond that they are joining, before the bridge adds the dialed telephone into the conference.

3. The conferencing bridge of claim 1 wherein the bridge stores alternative telephone numbers and messaging addresses for the desired participants, and a preferred order of messaging for each, and the bridge, at the time of the conference, accesses the stored information, accesses an appropriate messaging channel, and messages the desired participants according to the stored alternative numbers and addresses.

4. The conferencing bridge of claim 2 wherein the response by the desired participants is a pre-assigned digit or digit sequence.

5. The conferencing bridge of claim 3 wherein a response mechanism compatible with the appropriate messaging channel selected is implemented.

6. The conferencing bridge of claim 1 wherein a conference is configured with a list of participants, but without a time and date, and wherein the user accesses the bridge through an interactive interface to start a conference.

7. The conferencing bridge of claim 6 wherein the user, through the interactive interface, selects once to message all persons in the list to start a conference.

8. The conferencing bridge of claim 6 wherein the user, through the interactive interface, selects individual participants form the list, one-at-a-time or in sub groups, rather than all desired participants to initiate a conference.

9. The conferencing bridge of claim 6 wherein the user is notified as each participant joins the conference.

10. The conferencing bridge of claim 6 wherein the interactive interface includes a whisper function whereby the user is informed of specific aspects of the conference as the conference continues, the whisper not heard by other participants.
